(19) United States
(12) Patent Application Publication
(10) Pub. No.: US 2010/0094920 A1
(43) Pub. Date: Apr. 15, 2010

(54) DEVICE AND METHOD FOR EXECUTING FOURIER TRANSFORM

(75) Inventors: Sang In Cho, Daejeon (KR); Kyu-Min Kang, Daejeon (KR); Sangsung Choi, Daejeon (KR)

Correspondence Address: Jae Y. Park, Kile, Goekjian, Reed & McManus, PLLC, 1200 New Hampshire Ave. NW, Suite 570, Washington, DC, 20036, US

(73) Assignee: ELECTRONICS AND TELECOMMUNICATIONS RESEARCH INSTITUTE, Daejeon (KR)

(21) Appl. No.: 12/536,240

(22) Filed: Aug. 5, 2009

(30) Foreign Application Priority Data
Oct. 15, 2008 (KR) 10-2008-0101275

(51) Int. Cl. G06F 17/14

(52) U.S. Cl. 708/404

(57) ABSTRACT

A Fourier transform device generates a first sequence according to an input sequence based on a stored lookup table, and generates an output sequence by performing a butterfly operation on the first sequence a plurality of times. Therefore, hardware capacity and power consumption of the Fourier transform device can be reduced

### CROSS-REFERENCE TO RELATED APPLICATION

This application claims priority to and the benefit of Korean Patent Application No. 10-2008-0101275 filed in the Korean Intellectual Property Office on Oct. 15, 2008, the entire contents of which are incorporated herein by reference.

### BACKGROUND OF THE INVENTION

(a) Field of the Invention

The present invention relates to a Fourier transform method and device. Particularly, the present invention relates to a Fourier transform method and device using fast Fourier transform (FFT).

(b) Description of the Related Art

An orthogonal frequency division multiplexing (OFDM) scheme divides data with a high data rate into data strings with a low data rate, and simultaneously transmits them by using a plurality of subcarriers. In this instance, the block required for generating subcarriers and loading data is called a fast Fourier transform (FFT) processor.

In this OFDM based system, since the FFT processor is one of the blocks requiring much hardware, efficient realization is needed for hardware capacity, power consumption, and operational speed.

However, since the ultra wideband (UWB) system based on the multi-band orthogonal frequency division multiplexing (MB-OFDM) scheme must be realized as a parallel structure so that the FFT processor may satisfy the data rate required by the system, much hardware is required and large power consumption is generated.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a Fourier transform device for reducing hardware capacity needed for Fourier transform on data strings and a Fourier transform method for reducing power consumption on Fourier transform.

An exemplary embodiment of the present invention provides a method for Fourier transforming an input sequence including 2ⁿ complex values including: generating a first sequence including 2ⁿ complex values according to the 2ⁿ complex values included in the input sequence based on a stored lookup table; and generating an output sequence including 2ⁿ complex values by performing a butterfly operation (n-m) times based on the first sequence, wherein m is an integer which is less than n and is greater than 1.

The generating of a first sequence includes: dividing the 2ⁿ complex values included in the first sequence into a plurality of complex value groups; and searching the 2ⁿ complex values included in the first sequence from the lookup table according to the plurality of complex value groups.

The plurality of complex value groups include a first group, a second group, a third group, and a fourth group, and the searching includes searching a fifth complex value corresponding to a first complex value included in the first group, a second complex value included in the second group, a third complex value included in the third group, and a fourth complex value included in the fourth group, from the lookup table.

Another embodiment of the present invention provides a device for Fourier transforming an input sequence including 2ⁿ complex values, including: a first stage unit for outputting a first sequence corresponding to a result of performing a butterfly operation on the input sequence m times the input sequence based on a stored lookup table; and a plurality of stage units for outputting an output sequence by performing a butterfly operation on the first sequence (n-m) times, wherein n and m are positive integers.

The first sequence includes a plurality of complex values, and the first stage unit includes: a table storage unit for storing the lookup table including information on output complex values corresponding to a plurality of input complex values; a sequence divider for dividing 2ⁿ complex values included in the input sequence into a plurality of complex value groups according to a predetermined order; and a sequence output unit for outputting the first sequence by searching a plurality of complex values included in the first sequence from the lookup table based on the plurality of complex value groups.

The plurality of respective complex value groups include at least one complex value, and the first stage unit further includes a plurality of output controllers respectively corresponding to the plurality of complex value groups.

One of the plurality of output controllers receives one of the plurality of complex value groups from the sequence divider, and outputs a complex value included in the complex value group at each predetermined clock signal.

The second stage unit corresponding to one of the plurality of stage units includes: a storage unit for storing at least one complex value from among a plurality of complex values input to the second stage unit; and an operator for performing a predetermined butterfly operation on the complex value stored in the storage unit and a plurality of complex values input to the second stage unit.

### BRIEF DESCRIPTION OF THE DRAWINGS

FIG. 1 shows a conventional Fourier transform device.

FIG. 2 shows a butterfly operation method by a conventional Fourier transform device.

FIG. 3 shows a constellation of an input sequence input to a conventional Fourier transform device.

FIG. 4 shows a constellation of a first operation sequence output by a first stage unit of a conventional Fourier transform device.

FIG. 5 shows a constellation of a second operation sequence output by a second stage unit of a conventional Fourier transform device.

FIG. 6 shows a Fourier transform device according to an exemplary embodiment of the present invention.

FIG. 7 shows a first stage unit of a Fourier transform device according to an exemplary embodiment of the present invention.

FIG. 8 shows a Fourier transform method according to an exemplary embodiment of the present invention.

FIG. 9 shows a first sequence generating method according to an exemplary embodiment of the present invention.

FIG. 10 shows a method for a first stage unit to generate a first sequence based on an input sequence according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

A Fourier transform method and device according to an exemplary embodiment of the present invention will be explained with reference to accompanying drawings.

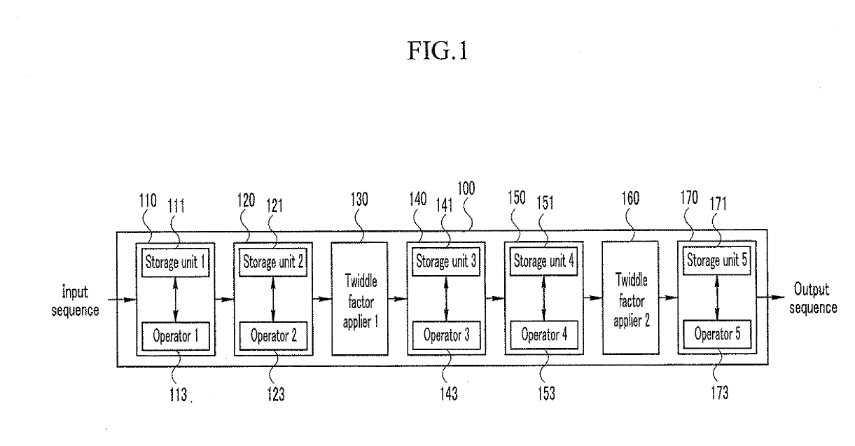

A conventional Fourier transform device will now be described with reference to FIG. 1.

FIG. 1 shows a conventional Fourier transform device.

As shown in FIG. 1, the conventional Fourier transform device 100 applies a fast Fourier transform (FFT) on an input sequence in the time domain to output an output sequence in the frequency domain, and it includes a first stage unit 110, a second stage unit 120, a first twiddle factor applier 130, a third stage unit 140, a fourth stage unit 150, a second twiddle factor applier 160, and a fifth stage unit 170. In this instance, the input sequence includes 32 complex values, and the Fourier transform device 100 performs an output sequence on the 32 complex values to output an output sequence including the 32 complex values.

The first stage unit 110 performs a butterfly operation on the 32 complex values included in the input sequence to output a first operation sequence including the 32 complex values, and it includes a first storage unit 111 and a first operator 113. In this instance, the first storage unit 111 can store 16 complex values.

The second stage unit 120 performs a butterfly operation on the 32 complex values included in the first operation sequence to output a second operation sequence including the 32 complex values, and it includes a second storage unit 121 and a second operator 123. In this instance, the second storage unit 121 can store 8 complex values.

The first twiddle factor applier 130 outputs a first twiddle factor applied sequence including the 32 complex values by applying a first twiddle factor to the 32 complex values included in the second operation sequence.

The third stage unit 140 outputs a third operation sequence including 32 complex values by performing a butterfly operation on the 32 complex values included in the first twiddle factor applied sequence, and it includes a third storage unit 141 and a third operator 143. In this instance, the third storage unit 141 can store 4 complex values.

The fourth stage unit 150 outputs a fourth operation sequence including 32 complex values by performing a butterfly operation on the 32 complex values included in the third operation sequence, and it includes a fourth storage unit 151 and a fourth operator 153. In this instance, the fourth storage unit 151 can store two complex values.

The second twiddle factor applier 160 outputs a second twiddle factor applied sequence including 32 complex values by applying a second twiddle factor on the 32 complex values included in the fourth operation sequence.

The fifth stage unit 170 outputs an output sequence including 32 complex values by applying a butterfly operation on the 32 complex values included in the second twiddle factor applied sequence, and it includes a fifth storage unit 171 and a fifth operator 173. In this instance, the fifth storage unit 171 can store 1 complex value.

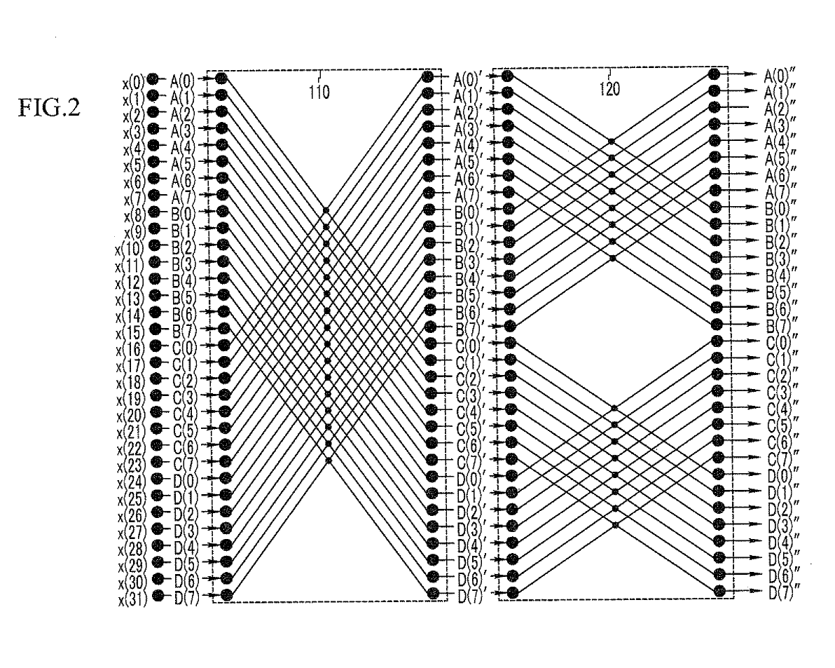

A butterfly operation method by the first stage unit and the second stage unit of the conventional Fourier transform device will now be described with reference to FIG. 2.

FIG. 2 shows a butterfly operation method of a conventional Fourier transform device.

As shown in FIG. 2, the Fourier transform device 100 receives an input sequence including 32 complex values. In this instance, the 32 complex values included in the input sequence follow Equation 1.

x(m), m=0, 1, 2, . . . , 31 (Equation 1)

In this instance, the 32 complex values included in the input sequence input to the first stage unit 110 can follow Equation 2.

x(m)=A(n), n=0,1,2, . . . ,7 when 0≦m<8

x(m)=B(n), n=0,1,2, . . . ,7 when 8≦m<16

x(m)=C(n), n=0,1,2, . . . ,7 when 16≦m<24

x(m)=D(n), n=0,1,2, . . . ,7 when 24≦m<32 (Equation 2)

When the 32 complex values included in the input sequence follow Equation 2, A(n), B(n), C(n), and D(n) respectively follow Equation 3.

A(n)=a(n)ᵣ+ja(n)ᵢ

B(n)=b(n)ᵣ+jb(n)ᵢ

C(n)=c(n)ᵣ+jc(n)ᵢ

D(n)=d(n)ᵣ+jd(n)ᵢ (Equation 3)

The first stage unit 110 performs a butterfly operation on the 32 complex values included in the input sequence according to Equation 4 to output a first operation sequence including 32 complex values.

A(n)′=A(n)+C(n)=(a(n)ᵣ+ja(n)ᵢ)+(c(n)ᵣ+jc(n)ᵢ)

B(n)′=B(n)+D(n)=(b(n)ᵣ+jb(n)ᵢ)+(d(n)ᵣ+jd(n)ᵢ)

C(n)′=A(n)−C(n)=(a(n)ᵣ+ja(n)ᵢ)−(c(n)ᵣ+jc(n)ᵢ)

D(n)′=B(n)−D(n)=(b(n)ᵣ+jb(n)ᵢ)−(d(n)ᵣ+jd(n)ᵢ) (Equation 4)

In this instance, A(n)′, B(n)′, C(n)′, and D(n)′ can be expressed as Equation 5 based on Equation 3.

A(n)′=a(n)ᵣ′+ja(n)ᵢ′=(a(n)ᵣ+c(n)ᵣ)+j(a(n)ᵢ+c(n)ᵢ)

B(n)′=b(n)ᵣ′+jb(n)ᵢ′=(b(n)ᵣ+d(n)ᵣ)+j(b(n)ᵢ+d(n)ᵢ)

C(n)′=c(n)ᵣ′+jc(n)ᵢ′=(a(n)ᵣ−c(n)ᵣ)+j(a(n)ᵢ−c(n)ᵢ)

D(n)′=d(n)ᵣ′+jd(n)ᵢ′=(b(n)ᵣ−d(n)ᵣ)+j(b(n)ᵢ−d(n)ᵢ) (Equation 5)

The second stage unit 120 performs a butterfly operation on the 32 complex values included in the first operation sequence according to Equation 6 to output a second operation sequence including 32 complex values.

A(n)″=A(n)′+B(n)′=(a(n)ᵣ′+ja(n)ᵢ′)+(b(n)ᵣ′+jb(n)ᵢ′)

B(n)″=A(n)′−B(n)′=(a(n)ᵣ′+ja(n)ᵢ′)−(b(n)ᵣ′+jb(n)ᵢ′)

C(n)″=C(n)′−jD(n)′=(c(n)ᵣ′+jc(n)ᵢ′)−j(d(n)ᵣ′+jd(n)ᵢ′)

D(n)″=C(n)′+jD(n)′=(c(n)ᵣ′+jc(n)ᵢ′)+j(d(n)ᵣ′+jd(n)ᵢ′) (Equation 6)

In this instance, A(n)′, B(n)″, C(n)″, and D(n)″ can be respectively expressed as Equation 7 based on Equation 5 and Equation 6.

A(n)″=a(n)ᵣ″+ja(n)ᵢ″=(a(n)ᵣ+c(n)ᵣ+b(n)ᵣ+d(n)ᵣ)+j(a(n)ᵢ+c(n)ᵢ+b(n)ᵢ+d(n)ᵢ)

B(n)″=b(n)ᵣ″+jb(n)ᵢ″=(a(n)ᵣ+c(n)ᵣ−b(n)ᵣ−d(n)ᵣ)+j(a(n)ᵢ+c(n)ᵢ−b(n)ᵢ−d(n)ᵢ)

C(n)″=c(n)ᵣ″+jc(n)ᵢ″=(a(n)ᵣ−c(n)ᵣ+b(n)ᵢ−d(n)ᵢ)+j(a(n)ᵢ−c(n)ᵢ−b(n)ᵣ+d(n)ᵣ)

D(n)″=d(n)ᵣ″+jd(n)ᵢ″=(a(n)ᵣ−c(n)ᵣ−b(n)ᵢ+d(n)ᵢ)+j(a(n)ᵢ−c(n)ᵢ+b(n)ᵣ−d(n)ᵣ) (Equation 7)

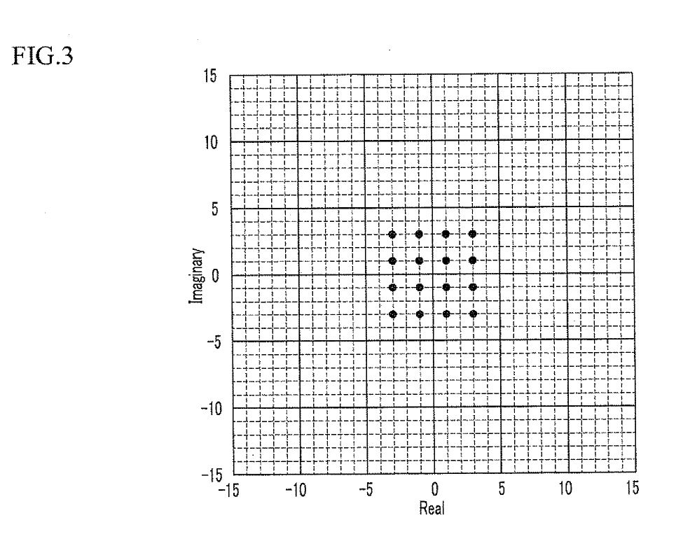

An input sequence input to a conventional Fourier transform device, a first operation sequence output by the first stage unit, and a second operation sequence output by the second stage unit will now be described with reference to FIG. 3 to FIG. 5.

FIG. 3 shows a drawing of a constellation of an input sequence input to a conventional Fourier transform device.

The constellation of the input sequence is illustrated as FIG. 3 when the input sequence input to the Fourier transform device 100 follows Equation 3, and fifth operators (n)ᵣ, a(n)ᵢ, b(n)ᵣ, b(n)ᵢ, c(n)ᵣ, c(n)ᵢ, d(n)ᵣ, and d(n)ᵢ respectively have one value of −3, −1, 1, and 1.

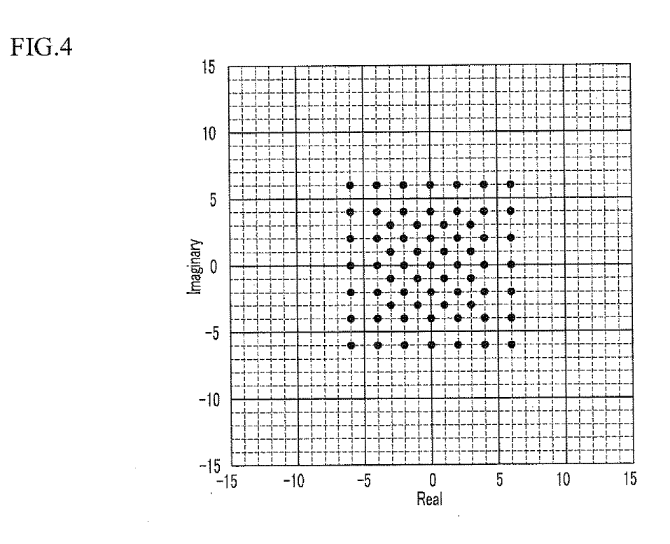

FIG. 4 shows a constellation of a first operation sequence output by a first stage unit of a conventional Fourier transform device.

The constellation of the first operation sequence is illustrated in FIG. 4 when the input sequence follows the constellation of FIG. 3 and the first stage unit 110 outputs the first operation sequence according to Equation 4 and Equation 5.

As shown in FIG. 4, a(n)ᵣ′, a(n)ₗ′, b(n)ᵣ′, b(n)ₗ′, c(n)ᵣ′, c(n)ₗ′, d(n)ᵣ′, and d(n)ₗ′ can respectively have one value of −6, −4, −3, −2, −1, 0, 1, 2, 3, 4, and 6.

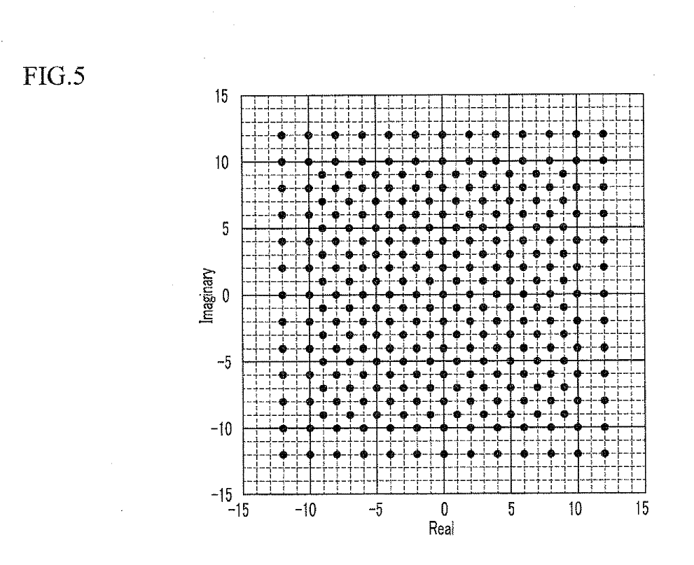

FIG. 5 shows a constellation of a second operation sequence output by a second stage unit of a conventional Fourier transform device.

The constellation of the second operation sequence is illustrated as FIG. 5 when the first operation sequence follows the constellation of FIG. 4 and the second stage unit 120 outputs the second operation sequence according to Equation 6 and Equation 7.

As shown in FIG. 5, a(n)ᵣ″, a(n)ₗ″, b(n)ᵣ″, b(n)ₗ″, c(n)ᵣ″, c(n)ₗ″, d(n)ᵣ″, and d(n)ₗ″ respectively have one of −12, −10, −9, −8, −7, −6, −5, −4, −3, −2, −1, 0, 1, 2, 3, 4, 5, 6, 7, 8, 9, 10, and 12.

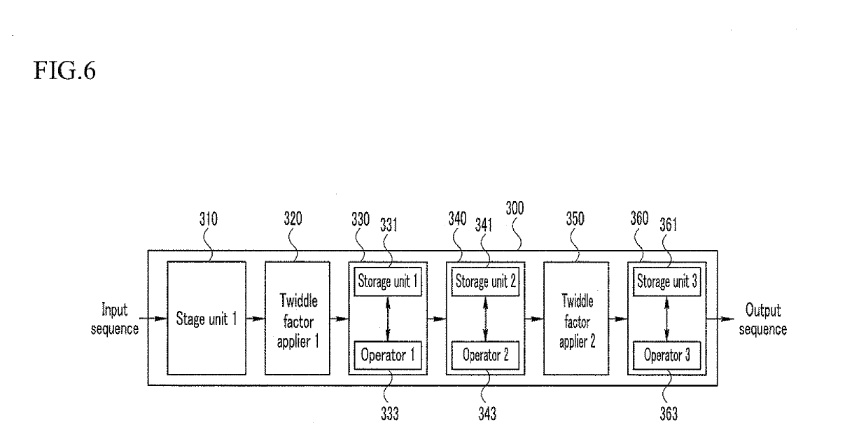

A Fourier transform device according to an exemplary embodiment of the present invention will now be described with reference to FIG. 6.

FIG. 6 shows a configuration of a Fourier transform device according to an exemplary embodiment of the present invention.

As shown in FIG. 6, the Fourier transform device 300 outputs an output sequence in the frequency domain by performing a fast Fourier transform (FFT) on the input sequence in the time domain, and it includes a first stage unit 310, a first twiddle factor applier 320, a second stage unit 330, a third stage unit 340, a second twiddle factor applier 350, and a fourth stage unit 360. In this instance, the input sequence includes 32 complex values, and the Fourier transform device 300 performs a FFT on the 32 complex values to output an output sequence including 32 complex values.

The first stage unit 310 outputs a first sequence including 32 complex values from the 32 complex values included in the input sequence according to a pre-stored lookup table. In this instance, the first sequence output by the first stage unit 310 corresponds to the second operation sequence output by the second stage unit 120 of the conventional Fourier transform device 100.

The first twiddle factor applier 320 applies a first twiddle factor to the 32 complex values included in the first sequence output by the first stage unit 310 to output a second sequence including 32 complex values. In this instance, the second sequence output by the first twiddle factor applier 320 corresponds to the first twiddle factor applied sequence output by first twiddle factor applier 130 of the conventional Fourier transform device 100.

The second stage unit 330 performs a butterfly operation on the 32 complex values included in the second sequence output by the first twiddle factor applier 320 to output a third sequence including 32 complex values, and it includes a first storage unit 331 and a first operator 333. In this instance, the first storage unit 331 can store 4 complex values. Also, the third sequence output by the second stage unit 330 corresponds to the third operation sequence output by the third stage unit 140 of the conventional Fourier transform device 100.

The third stage unit 340 performs a butterfly operation on 32 complex values included in the third sequence output by the second stage unit 330 to output a fourth sequence including the 32 complex values, and it includes a second storage unit 341 and a second operator 343. In this instance, the second storage unit 341 can store two complex values. Also, the fourth sequence output by the third stage unit 340 corresponds to the fourth operation sequence output by the fourth stage unit 150 of the conventional Fourier transform device 100.

The second twiddle factor applier 350 applies a second twiddle factor to the 32 complex values included in the fourth sequence output by the third stage unit 340 to output a fifth sequence including 32 complex values. In this instance, the fifth sequence output by the second twiddle factor applier 350 corresponds to the second twiddle factor applied sequence output by the second twiddle factor applier 160 of the conventional Fourier transform device 100.

The fourth stage unit 360 performs a butterfly operation on the 32 complex values included in the fifth sequence output by the second twiddle factor applier 350 to output a sixth sequence including 32 complex values, and it includes a third storage unit 361 and a third operator 363. In this instance, the third storage unit 361 can store 1 complex value. Also, the sixth sequence output by the fourth stage unit 360 corresponds to the fifth operation sequence output by the fifth stage unit 170 of the conventional Fourier transform device 100.

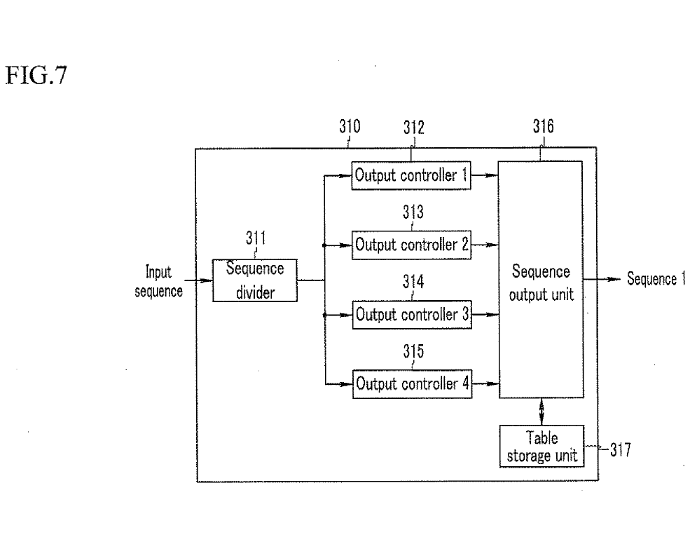

A first stage unit of a Fourier transform device according to an exemplary embodiment of the present invention will now be described with reference to FIG. 7.

FIG. 7 shows a configuration of a first stage unit of a Fourier transform device according to an exemplary embodiment of the present invention.

As shown in FIG. 7, the first stage unit 310 of the Fourier transform device 300 divides the 32 complex values included in the input sequence into four complex value groups according to the input order and outputs the first sequence from the four complex value group based on the lookup table, and it includes a sequence divider 311, a first output controller 312, a second output controller 313, a third output controller 314, a fourth output controller 315, a sequence output unit 316, and a table storage unit 317.

The sequence divider 311 divides the 32 complex values included in the input sequence into the four complex value groups according to the input order, and respectively transmits the four complex value groups to the first output controller 312, the second output controller 313, the third output controller 314, and the fourth output controller 315.

When the input sequence follows Equation 1, the sequence divider 311 can divide the 32 complex values included in the input sequence into four complex value groups A(n), B(n), C(n), and D(n) according to Equation 2, and can respectively transmit the first complex value group A(n), the second complex value group B(n), the third complex value group C(n), and the fourth complex value group D(n) to the first output controller 312, the second output controller 313, the third output controller 314, and the fourth output controller 315.

In this instance, the complex values included in the four complex value groups can follow Equation 3, and a(n)ᵣ, a(n)ᵢ, b(n)ᵣ, b(n)ᵢ, c(n)ᵣ, c(n)ᵢ, d(n)ᵣ and d(n)ᵢ can respectively have one value of k₁, k₂, k₃, and k₄.

The first output controller 312 transmits the 8 complex values included in the transmitted first complex value group A(n) to the sequence output unit 316 one by one according to the input order.

The second output controller 313 transmits the 8 complex values included in the transmitted second complex value group B(n) to the sequence output unit 316 one by one according to the input order.

The third output controller 314 transmits the 8 complex values included in the transmitted third complex value group C(n) to the sequence output unit 316 one by one according to the input order.

The fourth output controller 315 transmits the 8 complex values included in the transmitted fourth complex value group D(n) to the sequence output unit 316 one by one according to the input order.

The sequence output unit 316 outputs the first sequence according to the complex values input by the first output controller 312, the second output controller 313, the third output controller 314, and the fourth output controller 315 based on the lookup table stored in the table storage unit 317. In this instance, the first sequence output by the sequence output unit 316 can follow Equation 7.

The table storage unit 311 stores a plurality of lookup tables. In this instance, the table storage unit 311 can store a first lookup table including first address values (1-66536) according to real values and imaginary values of the complex values output by the 4 complex value groups, and the first lookup table can follow Table 1.

TABLE 1

| | x(m) | | | | | | | |
|---|---|---|---|---|---|---|---|---|
| Address | A(n) | | B(n) | | C(n) | | D(n) | |
| values 1 | a(n)ᵣ | a(n)ᵢ | b(n)ᵣ | b(n)ᵢ | c(n)ᵣ | c(n)ᵢ | d(n)ᵣ | d(n)ᵢ |
| 1 | k₁ | k₁ | k₁ | k₁ | k₁ | k₁ | k₁ | k₁ |
| 2 | k₁ | k₁ | k₁ | k₁ | k₁ | k₁ | k₁ | k₂ |
| 3 | k₁ | k₁ | k₁ | k₁ | k₁ | k₁ | k₁ | k₃ |
| 4 | k₁ | k₁ | k₁ | k₁ | k₁ | k₁ | k₁ | k₄ |
| 5 | k₁ | k₁ | k₁ | k₁ | k₁ | k₁ | k₂ | k₁ |
| . | . | | | | | | | |
| . | . | | | | | | | |
| . | . | | | | | | | |
| 65535 | k₄ | k₄ | k₄ | k₄ | k₄ | k₄ | k₄ | k₃ |
| 65536 | k₄ | k₄ | k₄ | k₄ | k₄ | k₄ | k₄ | k₄ |

Also, the table storage unit 311 can store a second lookup table including second address values (6-65536) corresponding to the first address values and third address values (K_{1,1}-K_{8,65536}) for the output values of the complex values corresponding to the second address values, and the second lookup table can follow Table 2.

TABLE 2

| | x(m)″ | | | | | | | |
|---|---|---|---|---|---|---|---|---|
| | A(n)″ | | B(n)″ | | C(n)″ | | D(n)″ | |
| Address values 2 | a(n)ᵣ″ | a(n)ᵢ″ | b(n)ᵣ″ | b(n)ᵢ″ | c(n)ᵣ″ | c(n)ᵢ″ | d(n)ᵣ″ | d(n)ᵢ″ |
| 1 | K_{1,1} | K_{2,1} | K_{3,1} | K_{4,1} | K_{5,1} | K_{6,1} | K_{7,1} | K_{8,1} |
| 2 | K_{1,2} | K_{2,2} | K_{3,2} | K_{4,2} | K_{5,2} | K_{6,2} | K_{7,2} | K_{8,2} |
| 3 | K_{1,3} | K_{2,3} | K_{3,3} | K_{4,3} | K_{5,3} | K_{6,3} | K_{7,3} | K_{8,3} |
| 4 | K_{1,4} | K_{2,4} | K_{3,4} | K_{4,4} | K_{5,4} | K_{6,4} | K_{7,4} | K_{8,4} |
| 5 | K_{1,5} | K_{2,5} | K_{3,5} | K_{4,5} | K_{5,5} | K_{6,5} | K_{7,5} | K_{8,5} |
| . | . | | | | | | | |
| . | . | | | | | | | |
| . | . | | | | | | | |
| 65535 | K_{1,65535} | K_{2,65535} | K_{3,65535} | K_{4,65535} | K_{5,65535} | K_{6,65535} | K_{7,65535} | K_{8,65535} |
| 65536 | K_{1,65536} | K_{2,65536} | K_{3,65536} | K_{4,65536} | K_{5,65536} | K_{6,65536} | K_{7,65536} | K_{8,65536} |

Also, the table storage unit 311 can store a third lookup table including output values including the third address values. In this instance, when k₁, k₂, k₃, and k₄ included in the first table respectively have one value of −3, −1, 1, and 1, the third lookup table can follow Table 3.

TABLE 3

| Address values 3 | Output values |
|---|---|
| 1 | −12 |
| 2 | −10 |
| 3 | −9 |
| 4 | −8 |
| 5 | −7 |
| 6 | −6 |
| 7 | −5 |
| 8 | −4 |
| 9 | −3 |
| 10 | −2 |
| 11 | −1 |
| 12 | 0 |
| 13 | 1 |
| 14 | 2 |
| 15 | 3 |
| 16 | 4 |
| 17 | 5 |
| 18 | 6 |
| 19 | 7 |
| 20 | 8 |
| 21 | 9 |
| 22 | 10 |
| 23 | 12 |

In this instance, when the third lookup table follows Table 3, the third address values (K_{1,1}-K_{8,65536}) of the second lookup table following Table 2 can have one value of 1 to 23.

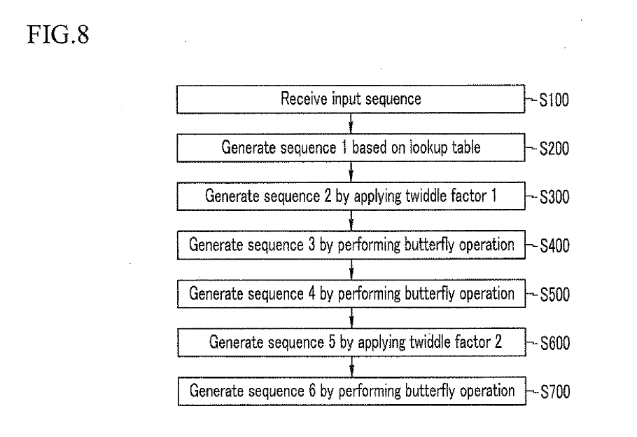

A method for a Fourier transform device according to an exemplary embodiment of the present invention to Fourier transform an input sequence will now be described with reference to FIG. 8.

FIG. 8 shows a Fourier transform method according to an exemplary embodiment of the present invention.

As shown in FIG. 8, the Fourier transform device 300 receives an input sequence including 32 complex values (S100).

The first stage unit 310 generates a first sequence including 32 complex values from the 32 complex values included in the received input sequence based on the stored lookup table (S200).

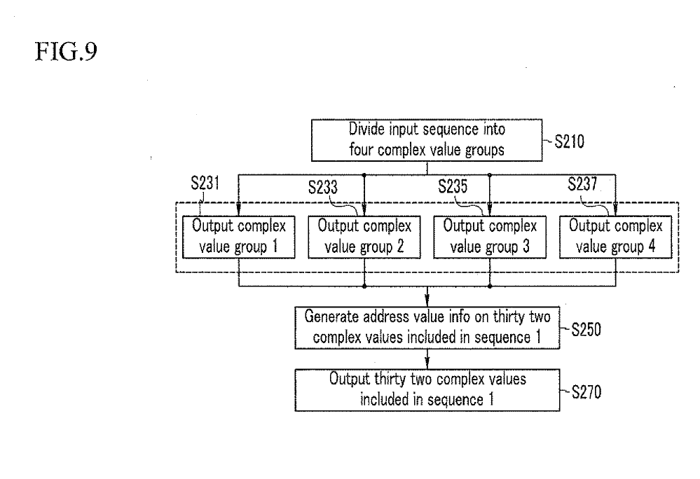

A method for the first stage unit 310 of the Fourier transform device 300 according to an exemplary embodiment of the present invention to generate a first sequence will now be described with reference to FIG. 9.

FIG. 9 shows a first sequence generating method according to an exemplary embodiment of the present invention.

As shown in FIG. 9, the sequence divider 311 divides the 32 complex values included in the input sequence into four complex value groups according to the input order to respectively transmit the four complex value groups to the four output controllers 312, 313, 314, and 315 (S210).

In this instance, the input sequence follows Equation 1, the four complex value groups respectively correspond to the first complex value group A(n), the second complex value group B(n), the third complex value group C(n), and the fourth complex value group D(n)) according to Equation 2, and the respective complex value groups include 8 complex values.

The first output controller 312 outputs the 8 complex values included in the transmitted first complex value group A(n) one by one according to the input order (S231).

In this instance, the second output controller 313 outputs the 8 complex values included in the second complex value group B(n) one by one according to the input order (S233).

Further, the third output controller 314 outputs the 8 complex values included in the transmitted third complex value group C(n) one by one according to the input order (S235).

Also, the fourth output controller 315 outputs the 8 complex values included in the transmitted fourth complex value group D(n) one by one according to the input order (S237).

The sequence output unit 316 generates address value information on the respective 32 complex values included in the first sequence by searching the first lookup table following Table 1 based on the complex value of the first complex value group A(n), the complex value of the second complex value group B(n), the complex value of the third complex value group C(n), and the complex value of the fourth complex value group D(n), and the second lookup table following Table 2 (S250).

The sequence output unit 316 outputs 32 complex values included in the first sequence by searching an output value corresponding to address value information generated based on the third lookup table following Table 3 (S270).

A method for a Fourier transform device according to an exemplary embodiment of the present invention to Fourier transform an input sequence will now be described with reference to FIG. 8.

The first twiddle factor applier 320 generates a second sequence including 32 complex values by applying a first twiddle factor to the 32 complex values included in the first sequence (S300).

The second stage unit 330 generates a third sequence including 32 complex values by performing a butterfly operation on the 32 complex values included in the second sequence S400.

The third stage unit 340 generates a fourth sequence including 32 complex values by performing a butterfly operation on the 32 complex values included in the third sequence (S500).

The second twiddle factor applier 350 generates a fifth sequence including 32 complex values by applying a second twiddle factor to the 32 complex values included in the fourth sequence (S600).

The fourth stage unit 360 generates a sixth sequence including 32 complex values by performing a butterfly operation on the 32 complex values included in the fifth sequence (S700).

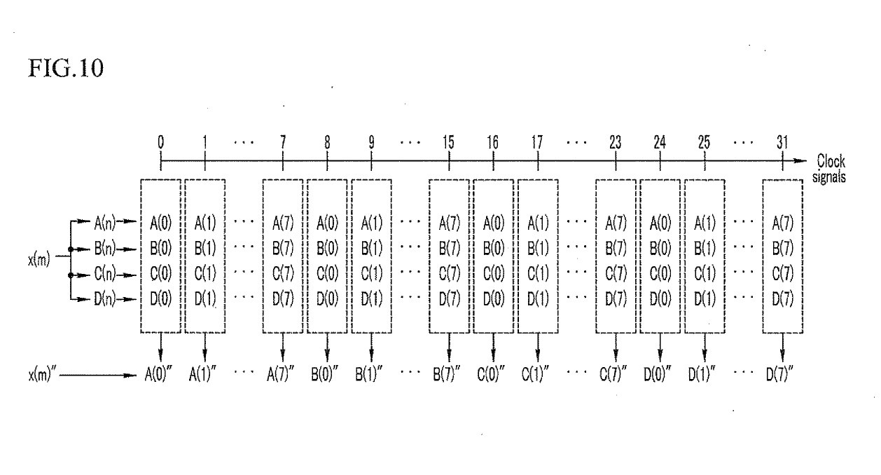

A method for a first stage unit of a Fourier transform device according to an exemplary embodiment of the present invention to generate a first sequence based on an input sequence will now be described with reference to FIG. 10.

FIG. 10 shows a method for a first stage unit according to an exemplary embodiment of the present invention to generate a first sequence based on an input sequence.

As shown in FIG. 10, the sequence divider 311 of the first stage unit 310 according to an exemplary embodiment of the present invention divides the received input sequence x(m) into four complex value groups, that is, the first complex value group A(n), the second complex value group B(n), the third complex value group C(n), and the fourth complex value group D(n). In this instance, the four complex value groups respectively include 8 complex values.

When the first output controller 312, the second output controller 313, the third output controller 314, and the fourth output controller 315 of the first stage unit 310 respectively control outputs of the first complex value group A(n), the second complex value group B(n), the third complex value group C(n), and the fourth complex value group D(n) to output A(n), B(n), C(n), and D(n) between clock signals 0-7, the sequence output unit 316 of the first stage unit 310 outputs A(0)″, A(1)″, . . . , A(7)″ according to A(n), B(n), C(n), and D(n) that are output for the respective clock signals based on the lookup table stored in the table storage unit 317.

When the first output controller 312, the second output controller 313, the third output controller 314, and the fourth output controller 315 of the first stage unit 310 respectively output A(n), B(n), C(n), and D(n) between the clock signals 8-15, the sequence output unit 316 of the first stage unit 310 outputs B(0)″, B(1)″, . . . , B(7)″ according to A(n), B(n), C(n), and D(n) that are output by respective clock signals based on the lookup table stored in the table storage unit 317.

When the first output controller 312, the second output controller 313, the third output controller 314, and the fourth output controller 315 of the first stage unit 310 respectively output A(n), B(n), C(n), and D(n) between the clock signals 16 to 23, the sequence output unit 316 of the first stage unit 310 outputs C(0)″, C(1)″, . . . , C(7)″ according to A(n), B(n), C(n), and D(n) that are output by respective clock signals based on the lookup table stored in the table storage unit 317.

When the first output controller 312, the second output controller 313, the third output controller 314, and the fourth output controller 315 of the first stage unit 310 output A(n), B(n), C(n), and D(n) between the clock signals 24 to 31, the sequence output unit 316 of the first stage unit 310 outputs D(0)″, D(1)″, . . . , D(7)″ according to A(n), B(n), C(n), and D(n) that are output by the respective clock signals based on the lookup table stored in the table storage unit 317.

Accordingly, the first stage unit 310 outputs the first sequence x(m)″ from the input sequence x(m) based on the lookup table.

According to the embodiments of the present invention, hardware capacity of the Fourier transform device can be reduced by substituting for part of the butterfly operation by using a stored lookup table, and power consumption of the Fourier transform device can be reduced.

Also according to the embodiments of the present invention, the operational speed of the Fourier transform device is increased since no actual calculation is performed when the lookup table is used, and performance of the Fourier transform device can be improved by reducing a quantization error or a round-off error since quantization performed before the butterfly operation is performed can be omitted.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for Fourier transforming an input sequence including 2ⁿ complex values, comprising:
generating a first sequence including 2ⁿ complex values according to the 2ⁿ complex values included in the input sequence based on a stored lookup table; and
generating an output sequence including 2ⁿ complex values by performing a butterfly operation (n-m) times based on the first sequence, wherein
m is an integer which is less than n and is greater than 1.

2. The method of claim 1, wherein
the generating of a first sequence includes:
dividing the 2ⁿ complex values included in the first sequence into a plurality of complex value groups; and
searching the 2ⁿ complex values included in the first sequence from the lookup table according to the plurality of complex value groups.

3. The method of claim 2, wherein
the plurality of complex value groups include a first group, a second group, a third group, and a fourth group, and
the searching includes
searching a fifth complex value corresponding to a first complex value included in the first group, a second complex value included in the second group, a third complex value included in the third group, and a fourth complex value included in the fourth group, from the lookup table.

4. A device for Fourier transforming an input sequence including 2ⁿ complex values, comprising:
a first stage unit for outputting a first sequence corresponding to a result of performing a butterfly operation on the input sequence m times based on a stored lookup table; and
a plurality of stage units for outputting an output sequence by performing a butterfly operation on the first sequence (n-m) times, wherein
n and m are positive integers.

5. The device of claim 4, wherein
the first sequence includes a plurality of complex values, and
the first stage unit includes:
a table storage unit for storing the lookup table including information on output complex values corresponding to a plurality of input complex values;
a sequence divider for dividing 2ⁿ complex values included in the input sequence into a plurality of complex value groups according to a predetermined order; and
a sequence output unit for outputting the first sequence by searching a plurality of complex values included in the first sequence from the lookup table based on the plurality of complex value groups.

6. The device of claim 5, wherein
the plurality of respective complex value groups include at least one complex value, and
the first stage unit further includes a plurality of output controllers respectively corresponding to the plurality of complex value groups.

7. The device of claim 6, wherein
one of the plurality of output controllers receives one of the plurality of to complex value groups from the sequence divider, and outputs a complex value included in the complex value group at each predetermined clock signal.

8. The device of claim 4, wherein
the second stage unit corresponding to one of the plurality of stage units includes:
a storage unit for storing at least one complex value from among a plurality of complex values input to the second stage unit; and
an operator for performing a predetermined butterfly operation on the complex value stored in the storage unit and a plurality of complex values input to the second stage unit.
